(19) United States
(12) Patent Application Publication
(10) Pub. No.: US 2004/0003247 A1
(43) Pub. Date: Jan. 1, 2004

(54) Non-centralized secure communication services

(76) Inventors: John D. Fraser, Golden Valley, MN (US); Peter L. Palmer, St. Paul, MN (US); Jeffry H. Hallgren, Excelsior, MN (US)

Correspondence Address: SHUMAKER & SIEFFERT, P. A., 8425 SEASONS PARKWAY, SUITE 105, ST. PAUL, MN, 55125, US

(21) Appl. No.: 10/386,380

(22) Filed: Mar. 10, 2003

Related U.S. Application Data
(60) Provisional application No. 60/363,156, filed on Mar. 11, 2002.
(60) Provisional application No. 60/363,468, filed on Mar. 11, 2002.
(60) Provisional application No. 60/363,467, filed on Mar. 11, 2002.

(51) Int. Cl. H04L 9/00

(52) U.S. Cl. 713/169

(57) ABSTRACT

In general, peer-to-peer techniques are described for providing secure communications using digital certificates assigned to secure communication servers (SCSs). The secure communication techniques allows enterprise users to communicate data securely between on another without requiring a centralized system. The SCS provides the secure communication services, such as certification authentication, usually provided by the centralized system. The non-centralized secure communication services provide high fault-tolerance, so that the failure of any system, communication link or other infrastructure will only affect the communication sessions directly associated with the infrastructure experiencing failure.

This application claims priority from U.S. Provisional Application Serial No. 60/363,156, filed Mar. 11, 2002, U.S. Provisional Application Serial No. 60/363,468, filed Mar. 11, 2002, and U.S. Provisional Application Serial No. 60/363,467, filed Mar. 11, 2002, the entire contents of which is incorporated herein by reference.

### TECHNICAL FIELD

The invention relates to computer networks, and more particularly, to secure electronic communications via computer networks.

### BACKGROUND

Companies and individuals need a simple but secure mechanism to share information over networks, such as the Internet. Currently, companies spend large amounts of money on private networks, dial-up modems and other mechanisms to achieve this goal.

Further, managing remote access to files has been an on-going challenge since the advent of wide area networks in general, but has become an even greater management challenge since the emergence of the Internet. Individual enterprises such as corporations, government agencies, and universities, have a need to make files available to remote users. However, a single method or protocol that would broadly meet this need has not emerged. Some popular methods used today in a local environment include Network File System (NFS), SMB, and SAMBA. For remote access to these files, File Transfer Protocol (FTP) and Secure Copy (SCP) are used. However, conventional systems are unable to provide both a simple user interface as well as high security and audit features that are needed to support broad scale adoption.

### SUMMARY

In general, techniques are described that utilize a secure communications server (SCS) and other unique technologies to provide secure communications. The secure communications may be between enterprise users within an enterprise, or between enterprise users within different respective enterprises. The SCS provides support for many-to-many secure communication sessions as well as many-to-one communications.

Unlike conventional methods of supplying secure communications that typically rely upon a central service, central server, or central directory system to ensure secure encrypted communications, the SCS allows enterprise users to directly communicate with each other without the need for any centralized systems. For example, the SCS provides many secure communication services, such as certification authentication, that usually require a centralized system. More specifically, the SCS may provide peer-to-peer authentication to validate the identity of another device. In addition, the non-centralized secure communication services provide high fault-tolerance, so that the failure of any system, communication link or other infrastructure will only affect the communication sessions directly associated with the infrastructure experiencing failure. Moreover, the non-centralized secure communication services ensure that the community has a secure, robust communications system.

As will be described, distributed SCSs support cryptographically protected streaming services between enterprises. In particular, any of the enterprises can open any type of cryptographically protected communication with other enterprises to provide direct and secure computer-to-computer communications between arbitrary enterprise users of the respective enterprises. The distributed SCSs receive requests to initiate communications between the enterprises, and automatically form secure communication tunnels between proxy software executing on the SCSs.

In distributed, peer-to-peer fashion, the SCSs form direct secure communications between client devices of enterprises using digital certificates or other encryption keys assigned to the SCSs. The SCSs may form tunnels referred to herein as “cryptographically authenticated tunnels.” In addition, the SCSs may establish encrypted communication channels, such as secure sockets layer (SSL) channels. The direct, secure communications established between enterprise users of respective enterprises allows the SCSs to facilitate cryptographically protected file transfers between computing devices within respective enterprises. Additionally, the secure communications may establish a real-time connection between computing devices within respective enterprises. Further, the secure communications may be used to provide enterprise users that are cryptographically verified with access to secure web-folders maintained by the SCSs. The SCSs provide a secure communications manager that provides the ability to log the current and past activity on the system and review the logs in order to manage the secure communications.

In addition to the above services, the SCSs may interact with a secure client process that provides secure communication services locally on a computing device of an enterprise user. The secure client process may, for example, be a separate software component written to operate on Microsoft Windows computer systems. The secure client process provides an encryption and decryption service that allows the secure client process to encrypt information sent to the SCS, and to decrypt information downloaded from an SCS that was encrypted for the secure client service by the SCS. The secure client process and the SCS provide an authentication service that requires that each system prove their respective identities using an X509v3-compliant cryptographic handshake and verification.

In one embodiment, the invention provides a method comprising requesting a secure communication flow between devices, authenticating an identity of each of the devices using peer-to-peer authentication, and establishing a secure communication flow between the devices upon authenticating the identity of each of the devices.

In another embodiment, the invention provides a system comprising a first device and a second device, wherein first and second device authenticate one another using peer-to-peer authentication, and establish a secure communication flow between the devices upon authenticating the identity of each of the devices.

In another embodiment, the invention provides a secure communication device comprising an authentication manager to authenticate an identity of a device using peer-to-peer authentication and a security manager to establish a secure communication flow to communicate with the device upon authentication.

In another embodiment, the invention provides a system comprising a server hosting a web-accessible, cryptographically protected file system and a client device to remotely access the file system, wherein the server requires a digital certificate and a private key to grant the client access to the file system.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a system in which a plurality of enterprises directly communicate over a network using secure communications provided by corresponding secure communication servers (SCSs).

FIG. 2 is a block diagram illustrating a portion of the system of FIG. 1 in further detail.

FIG. 3 is a block diagram illustrating an exemplary SCS that provides secure communications in accordance with the invention.

FIG. 4 is a block diagram illustrating an exemplary user interface for a user to access a cryptographically protected file system managed by an SCS.

FIG. 5 is a screen shot that illustrates a graphical user interface provided by secure client software that interacts with SCS to provide security and ease-of-use services.

FIG. 6 is a flow diagram illustrating secure file transfer between two SCSs.

FIG. 7 is a flow diagram illustrating secure data transfer between a secure client process and an SCS.

FIG. 8 is a flow diagram illustrating an SCS allowing a remote enterprise user to access a secure web folder.

### DETAILED DESCRIPTION

In general, a secure communications server (SCS) is described herein that utilizes unique peer-to-peer technologies to provide secure communications. The secure communications may be between enterprise users within an enterprise or between enterprise users within different respective enterprises. The SCS provides support for many-to-many secure communication sessions that may be used to establish a distributed, secure communication “infrastructure” directly between peer computing devices. This type of communication infrastructure is useful, for example, for providing a method to securely exchange patient-identifiable data that is now protected under the new Health Insurance Portability and Accountability Act (HIPAA). One example type of data exchange that may be facilitated using these techniques is a patient referral to another physician. Another example that many-to-many secure communications may support is the secure submission of electronic claims to insurance companies for health care and other industries.

In other embodiments, the SCS provides support for many-to-one communications. An example of this type of data exchange is in public health reporting from clinics, hospital emergency rooms or laboratories to report an infectious disease outbreak that may signal a bioterrorist threat. In this example, information may be collected by a central organization, like a state Department of Health from these distribute clinics and hospitals, and ultimately flow to the Federal Centers for Disease Control and Prevention (CDC).

Conventional methods of supplying secure communications typically rely upon a central computer, central server, or central directory system to provide services necessary to ensure secure encrypted communications. For example, conventional techniques often rely on a centralized certification authority to valid digital certificate or other digital credentials. Unlike these systems, the SCS allows enterprise users to directly establish secure, authenticated communication without relying on a centralized system. In other words, the SCS provides the secure communication services, such as certificate authentication, usually provided by the centralized system. The non-centralized secure communication services provide high fault-tolerance, so that the failure of any system, communication link or other infrastructure will only affect the communication sessions directly associated with the infrastructure experiencing failure. As a result, the non-centralized secure communication services ensure that the community has a secure, robust communications system.

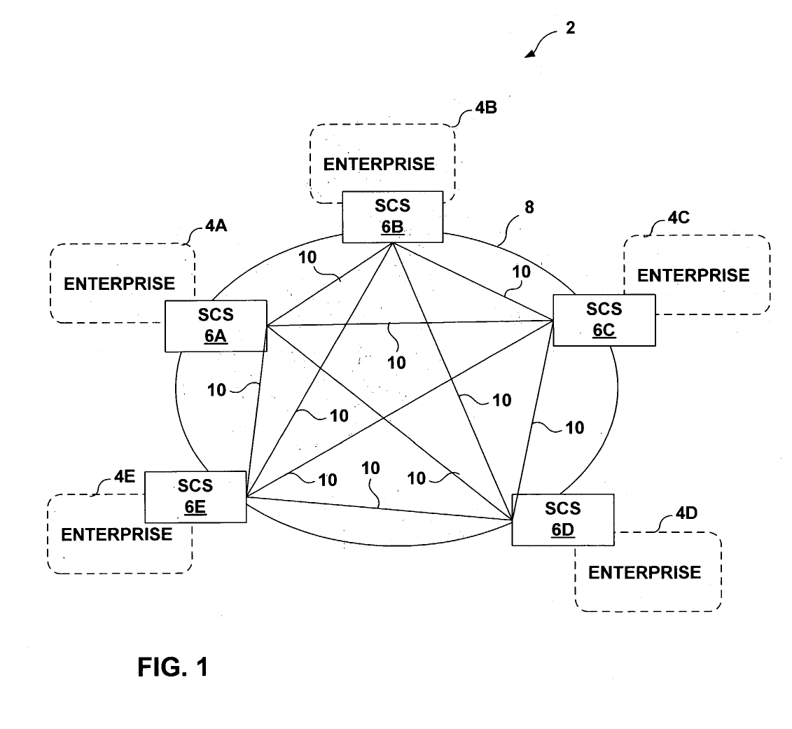

FIG. 1 is a block diagram illustrating a system 2 in which enterprises 4A-4E (“enterprises 4”) directly communicate over network 8 using secure communications provided by secure communication servers (SCSs) 6A-6E (“SCSs 6”). Network 8 maybe a private or semi-private network, or a public network, such as the Internet, that includes one or more autonomous systems (not shown) having a number of devices, such as routers and switches, used to forward data.

Each of enterprises 4 may include one or more computing devices (not shown), such as personal computers, laptop computers, handheld computers, workstations, servers, routers, switches, printers, fax machines, or the like. Enterprises 4 may further include at least one enterprise site network linking the computing devices. Example site networks include one or more Local Area Networks (LANs), Wide Area Network (WANs) or the like. Enterprises 4 may be different entities, such as health care providers, e.g., hospitals or clinics. Alternatively, enterprises 4 may further be geographically distributed sites of a common entity. For example, enterprises 4 may be enterprise sites for a common health care insurance company, such as Blue Cross Blue Shield, with geographically distributed sites throughout the United States.

As will be described, SCSs 6 provide cryptographically protected streaming services between enterprises 4. In particular, any of enterprises 4 can open any type of cryptographically protected tunnel 10 with other enterprises 4 to provide direct and secure computer-to-computer communications between enterprise users of the respective enterprises 4. SCSs 6 receive requests to initiate communications between enterprises 4, and automatically form secure communication tunnels 10 between proxy software executing on SCSs 6. SCSs 6 may, for example, form direct, secure communications between client devices of enterprises 4 using digital certificates and/or other encryption keys assigned to SCSs 6. In this manner, tunnels 10 may be cryptographically authenticated tunnels, encrypted communication channels, such as a secure sockets layer (SSL) channels, and the like.

The direct, secure communications established between enterprise users of respective enterprises 4 allows SCSs 6 to facilitate, for example, cryptographically protected file transfers between computing devices within respective enterprises 4. Additionally, the secure communications may establish a real-time connection between computing devices within respective enterprises 4. Further, the secure communications may be used to provide enterprise users that are cryptographically verified with access to secure web-folders maintained by SCSs 6. SCSs 6 provide a secure communications manager that provides the ability to log the current and past activity on the system and review the logs in order to manage the secure communications.

In addition to the above services, the SCSs may interact with a secure client process executing locally on a computing device of an enterprise user to provide secure communication services. The secure client process may, for example, be a separate software component written to operate on computer systems having the Microsoft Windows™ operating system. The secure client process provides encryption and decryption services on the computing device of the enterprise user that otherwise are usually performed by SCSs 6. The secure client process allows, for example, the users to interact with the systems to provide secure communications using a simple point-and-click interface. As a result, SCSs may be remote servers based on Linux or other operating system, and may not be directly accessible to end-users. In this manner, the secure client process brings the services provided by SCSs 6 to the enterprise user.

SCSs 6 may further provide a unique application program interface (API) to allow other vendors to adapt their services to use the peer-to-peer security infrastructure described herein. This API provides seamless connectivity for other vendor applications to be allowed to communicate both internally and to external trading partners in a secure manner. Some practical applications for this API include government reporting and tracking. This also allows community-developed software to make use of this security infrastructure.

In some embodiments, SCSs 6 include complete certificate authentication services. In other words, as a basis for the other services described herein, SCSs 6 provide a complete Certification Authority (CA) system that can be used to interface with other applications.

SCSs 6 may also support smartcards or other devices for storing and retrieving security credentials for individual users. Smartcards, for example, have a Public Key Infrastructure (PKI) or similar security system built into them. In this manner, SCSs 6 can provide support for this, enabling mobile users to access the system from any location.

SCSs 6 may also include customer electronic data interchange (EDI) interfaces. In this manner, a customer EDI provides support to allow participating information systems to directly link to the secure services offered by SCSs 6. SCSs 6 also mechanisms for defining and enforcing policies for allowing and encouraging this type of community resource. This means that when a single computing device has been configured to use the secure infrastructure provided by SCSs 6, similar systems can be deployed with minimal additional effort.

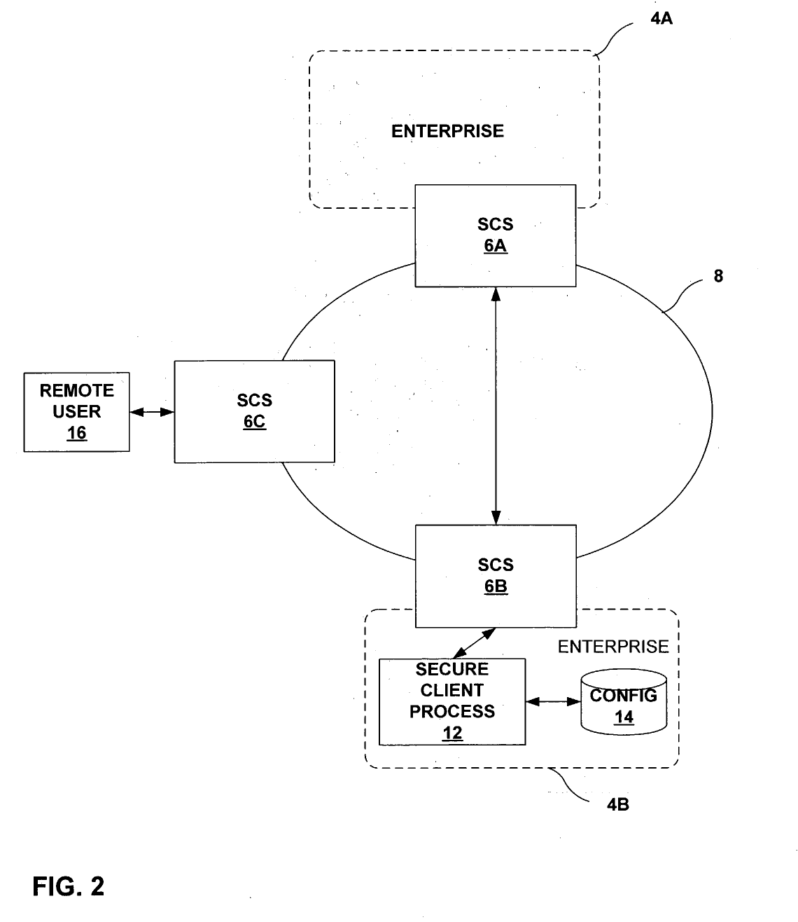

FIG. 2 is a block diagram illustrating a portion of system 2 of FIG. 1 in further detail. In accordance with the invention, enterprises 4A and 4B directly communicate over network 8 using secure communications provided by corresponding secure communication servers (SCSs) 6A and 6B, respectively. As described above, enterprises 4A and 4B may be customer site networks of different entities or geographically distributed customer sites of a common entity.

As described above, SCSs 6 automatically establish direct, bi-directional secure communications between enterprise 4A and 4B and, more particularly between enterprise users of the respective enterprises 4. More particularly, SCSs 6 provide a secure communication environment in which the specific identity of each SCS participating in the secure communication is cryptographically authenticated. Each SCS 6 may, for example, be issued a digital certificate or other digital credential for use in peer-wise authentication. In addition, SCSs 6 cryptographically confirm the specific identity of the enterprise user at each end of the direct, secure communication. The bidirectional authentication ensures non-repudiation of the identity of the enterprise user at the other end of the secure communication.

Once bidirectional authenticated of each SCS as well as the users occurs, SCSs 6 provide numerous services via the direct secure communication sessions established between enterprises 4A and 4B. SCSs 6 may provide secure transfer of data, such as files, between SCSs 6 via encrypted channels, such as an encrypted SSL channel. As another example, SCSs may establish cryptographically authenticated tunnels to provide encrypted, real-time secure communications between any two arbitrary ports SCSs 6. The cryptographically authenticated tunnels support real-time processing such as logging into a real-time computer application. The cryptographically authenticated tunnels also support two enterprise systems using the Internet to directly communicate with each other.

SCSs 6 automatically encrypt all communication between the two systems. More specifically, using the exchange of a file as an example, SCS 6A may prepare a file for encryption and encrypt the file. SCS 6A may, for example, encrypt the file using a public key of a public/private key pair associated with the destination SCS 6. SCS 6A sends the encrypted file via the established secure communication channel to the receiving SCS, e.g., SCS 6B. SCS 6B decrypts the file and relays the file to another server or to the enterprise user for further processing. SCS 6B may, for example decrypt the file using the private key of the public/private key pair. In this manner, only devices that have access to the private key of the public/private key pair may decrypt the file, in turn, ensuring that no unauthorized user may decrypt the file.

SCSs 6 may log all transactions between SCSs 6 and, more particularly, between the enterprise users in order to ensure that an audit trail is created to log and track all data flows between the enterprise users and associated SCSs 6. SCSs 6 may further handle delivery confirmation of data flows between SCSs 6. Each SCS 6 may provide a unique Graphical User Interface (GUI) to manage the secure communications. This GUI provides the ability to review the logs, showing current and past activities on the system. SCSs 6 also provide the ability to re-map ports to interconnect services that may need to access other services through non-traditional TCP/IP ports, which can otherwise be problematic between firewalled systems.

SCSs 6 may further provide access to secure web folders using certificate authentication/verification. In general, secure web folders can be accessed by a remote computer using cryptography based on the X.509v3 standard. Techniques are described for managing the availability of files that reside on a web server and that are associated with the web folders in such a way that to the end users it appears as a standard file system. The described techniques facilitate the controlled access to these files, and the secure communication of the data from the server to the remote computer that is accessing the data. In particular, the techniques may utilize Public Key Infrastructure (PKI) in conjunction with the technology for managing network files, e.g., Web-based Distributed Authoring and Versioning (WebDAV), which is a set of extensions to the HTTP protocol that allows users to collaboratively edit and manage files on remote web servers.

For example, a remote user 16 accesses a secure web folder on a desktop of a computer. A cryptographically authenticated channel is automatically established between a computer used by remote user 16 and an SCS 6C associated with the secure web folder. Specifically, SCS 6C authenticates remote user 16, for example, using a PKI certificate assigned to remote user 16. Upon validation of the PKI certificate of remote user 16, SCS 6C allows remote user 16 to access the secure file system directories. In this manner, SCSs 6 provide an authenticated “channel” from remote user 16 to files hosted on another computer anywhere in the world.

SCSs 6 may also provide secure communications between an SCS and a secure client process 12 that provides secure communication services similar to those provided by SCS locally on a computing device of an enterprise user. The secure client process 12 may, for example, be a software component written to operate on Microsoft Windows computer systems. The secure client process 12 provides an encryption and decryption service that allows the secure client process to encrypt information sent to an SCS 6, and to decrypt information downloaded from the SCS that was encrypted for the secure client process by the SCS.

In one embodiment, secure client process 12 requests a configuration server name or other identifier for an SCS from a configuration file or database (CONFIG) 14. Secure client process 12 may then request additional configuration information directly from the identified SCS, e.g., SCS 6B. Secure client process 12 and the SCS 6B provide an authentication service that requires that each of process 12 and SCS 6B prove their respective identities using, for example, an X509v3-compliant cryptographic handshake and verification. SCS 6B authenticates the secure client process 12, for example, by exchanging digital certificates with the secure client process, exchanging data encrypted with a private encryption key associated with each device and validating the authentication of the device when the encrypted data is successfully decrypted with a public key from the digital certificate.

Upon validation using PKI authentication, secure client process 12 is configured automatically by downloading from SCS 6B configuration information. This configuration information allows the enterprise user associated with the client device running secure client process 12 to then pick from a simple list each destination available on the SCS. Also included in this configuration information is the automatic download of the certificates needed to ensure the cryptographic security model. Secure client process 12 encrypts the data in accordance with the obtained certificates and sends the encrypted data to SCS 6B via an encrypted SSL channel established upon the bidirectional authentication. In other words, the encrypted channel may be established after both SCS 6B and secure client process 12 authenticate one another.

SCS 6B may also receive encrypted files for remote user 16 and leave them in a directory for the remote user. Remote user 16 may retrieve the files from the directory and decrypt the files using associated PKI keys.

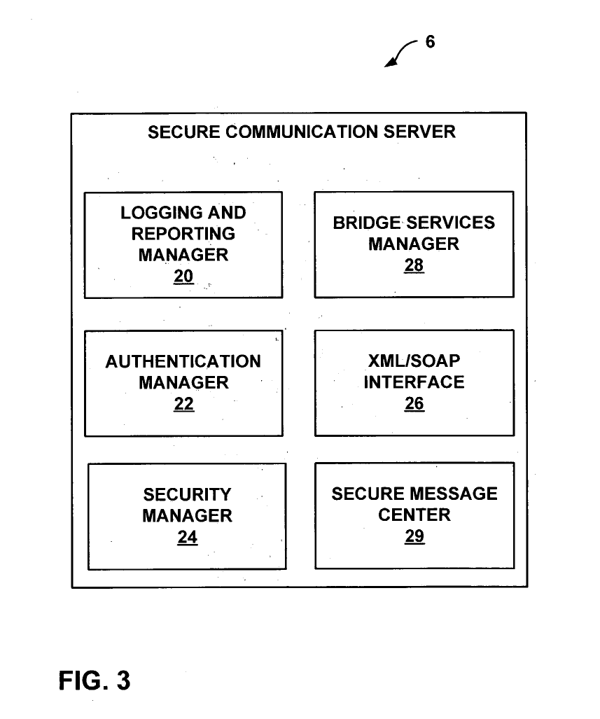

FIG. 3 is a block diagram illustrating an exemplary SCS 6 that provides peer-wise authentication and establishment of secure communications in accordance with the invention. SCS 6 provides secure communications for securely transferring files between SCS 6 and another SCS via encrypted channels, providing cryptographically authenticated tunnels for real-time data transfer, providing remote users with access to secure web folders, providing secure communications between SCS 6 and a secure client 16, and the like. As illustrated in the example of FIG. 3, SCS 6 includes a logging and reporting manager 20, an authentication manager 22, a security manager 24, an XML/SOAP interface 26 and a bridge service manager 28.

Logging and reporting manager 20 logs transactions between SCS 6 and other enterprise devices and/or users to ensure that an audit trail is created for tracking all data flows between the information trading partners. Logging and reporting manager 20 further provides a graphical user interface (GUI) to manage the secure communications. Specifically, the GUI provides the ability to review the logs, showing current and past activities on the system. By utilizing the GUI, SCS 6 provides a very easy-to-use system to set up encrypted tunnels for information flows across a network, e.g., the Internet. SCS 6 also provide the ability to re-map ports to interconnect services that may need to access other services through non-traditional TCP/IP ports, which can otherwise be problematic between fire-walled systems. SCS 6 may, for example, re-map ports to support service-to-service connections. Many legacy services operate on ports that firewalls will not allow to communicate over the Internet or other networks. By re-mapping these ports to other ports allowed by the firewalls, legacy applications can be interconnected within an enterprise, or between enterprises.

Authentication manager 22 is responsible for carrying out the bi-directional authentication of other devices that wish to establish encrypted channels or cryptographically authenticated tunnels with SCS 6. More specifically, authentication manager 22 receives digital certificates associated with the devices. Authentication manager 22 further receives a piece of encrypted data from the device requesting the secure communications. The requesting device uses a private encryption key of a public/private key pair associated with the device to encrypt the piece of data. Authentication manager 22 decrypts the piece of encrypted data with a public key of the device that is included in the digital certificate.

Security manager 24 provides all of the encryption, decryption, and other such services. For example, security manager 24 encrypts and decrypts specific files moving across the network, data flows through tunnels, and the like. Security manager 24 may further provide verification services to cryptographically verify identities of other SCS servers, secure client processes or secure web folder users, as well as verify the integrity of signed files.

XML/SOAP interface 26 enables secure remote access to objects on SCS 6. In other words, enterprise users can interact with SCS 6 using SOAP/XML calls to trigger secure communications with other enterprise users. XML/SOAP interface 26 also provides transaction services via Java Message Service interfaces. This allows enterprise users in two different enterprises 4 to interface to SCS 6 by using a local queuing environment, and connect to remote queuing environments via SCS 6 as a transparent, yet secure connection between disparate queuing systems.

Bridge service manager 28 provides SCS 6 with open bridge capabilities. Particularly, SCS supports a bridge trust model architecture to link together different PKI environments. Using this bridge trust model architecture, SCS 6 may confirm the validity of certificates issued by enterprises using a different authentication environment. SCS 6 may, for example, use bridge service manager 28 to verify emails encrypted by other certificates, verify file transfers that have been encrypted by other certificates, verify secure web-folders by cryptographically verifying the identify of the person trying to mount a secure web folder, or verify the identity of individuals accessing a secure message center (SMC) 29 using a web interface to verify digital certificates issued by others, as described in detail below.

In one embodiment, SCSs 6 make use of an integrated Lightweight Directory Access Protocol (LDAP) directory that provides a single point of authentication for multiple services. The LDAP directory stores the complete user identities with their associated PKI information. In this manner, SCS 6 integrates the authentication process across all aspects of a number of different services. Additional details of the LDAP directory-based security are described in further detail within co-pending U.S. patent application Ser. No. 10/307,232, entitled DIRECTORY-BASED SECURE COMMUNITIES, filed on Nov. 27, 2002, and bearing attorney docket number 1013-002US01, the entire content of which is hereby incorporated by reference.

As mentioned above, SCS 6 includes SMC 29 that may be accessed by individuals using a web interface. In general, the SMC provides an easy-to-use architecture that provides multiple types of secure, logged communications. SMC 29 may be used, for example, to provide communications between two sets of users having access to different resources and having different requirements. A first set of users, such as a set of doctors or clinicians, access SMC 29 using conventional email protocols, such as S/MIME, and using conventional email applications, such as Microsoft Outlook™. The second set of users, such as a set of patients, accesses SMC 29 using a web-based interface. SMC 29 provides secure communications between the users.

Access to the SCS and more particularly to SMC 29 can be protected multiple ways. For instance, access to SMC 29 from the public can be managed by assigning username/password pairs to remote enterprise users. Digital certificates issued to end-users may instead, cryptographically verify access to SMC 29 for any individual. SMC 29 can act as a gateway between the two sets of users, e.g., users accessing SMC 29 via username/password and users accessing SMC 29 via cryptographically verification. The secure communications with enterprise users may be established via a digital certificate assigned to SMC 29.

For example, SMC 29 can accept e-mails from PKI-enabled S/MIME clients, and automatically maps these S/MIME clients, via the directory, into usernames of a user database maintained by the SMC. This allows email to be exchanged from a variety of interfaces, and allows granular mapping of interactions between the different email clients.

SMC 29 provides email-based notification of pending messages. This system supports the unique ability to send an out-of-band e-mail to an external mail box of an enterprise user residing on another system to indicate that new information is waiting for them in their SMC mailbox. A single click on link information contained in the email will bring the user to a login screen presented by SMC 29, from which the use is able to read his or her email securely.

One example of how SMC 29 may be utilized is to allow health care providers, e.g., clinics, hospitals, and the like, to allow interaction between patients and their physicians. SMC 29 can be set up to notify users when new information is put into their secure mailbox. This can be automated so lab systems could auto-report lab results to the patient's email account in a secure manner using PKI-encrypted communications.

Providers could also use this SMC 29 to communicate between themselves. As a result, email accounts on one system can be used to communicate with accounts on another system via SMC 29. The secure infrastructure components of SCS 6 will validate the identity of individual users across systems using bridging techniques.

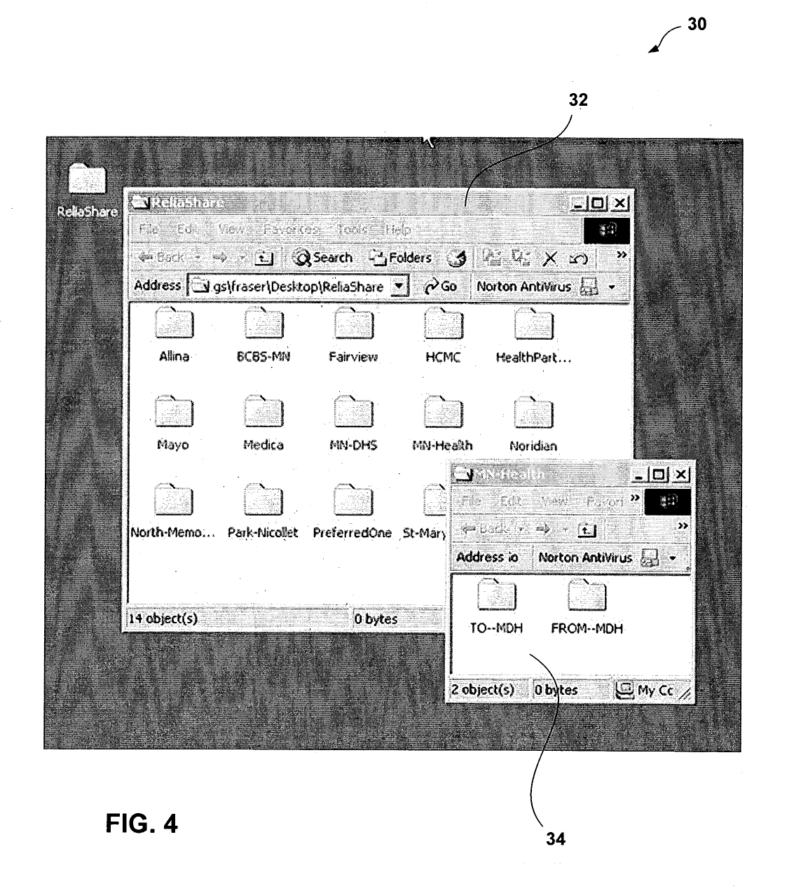

FIG. 4 is a block diagram illustrating an exemplary user interface 30 for a user to access a cryptographically protected file system managed by an SCS 6. As illustrated, user interface 20 provides an easy-to use file-sharing interface that allow enterprise users to drop files into appropriate folders associated with their information trading partners. These folders are monitored by an SCS, e.g., SCS 6 of FIG. 2, and files designated for a specific destination are encrypted with the public key of an SCS associated with that destination, and then transferred over an encrypted communication channel, e.g., a 128-bit SSL channel, to that SCS for decryption and delivery to the final destination.

SCS 6 may utilize the described security services in conjunction with WebDAV to securely transfer files to the other SCS. Secure client process 12 also uses these techniques to exchange files with the local SCS, i.e., SCS 6B. In this manner, an SCS 6 may, for example, provide techniques for managing encryption, authentication, and access controls for users remotely accessing protected folders network folders.

In this example, user interface 30 includes a first window 32 that shows available enterprises with which to communicate, such as Allina, Medica, Fariview Hospital, and the like. When an enterprise user, e.g., remote user 16, selects one of the folders, a second window 34 is displayed on his or her computer that reveals a source folder and a destination folder for securely communicating with the enterprises. In the illustrated example, second window 34 displays a folder “TO-MDH” for securely sending files to Minnesota Health (MN-Health), as well as a folder “FROM-MDH” for securely receiving files from Minnesota Health.

Upon accessing the secure web folder, remote user 16 is required to authenticate to hosting SCS 6 by presenting a digital certificate and an encrypted piece of data as a token to prove the identity of the remote user. In other words, the remote user must be in possession of a private key that corresponds to a unique public key contained in their x509 digital certificate obtained by SCS 6 in order to be granted access to a particular file.

Once the identity of remote user 16 has been authenticated, SCS 6 allows the remote user to access the files of the secure web server. The data flow from SCS 6 is encrypted all the way to remote user 16 with the public key associated with the remote user. This insures that any person or process monitoring the communication cannot discover the contents unless they are in possession of the private key of remote user 16.

In addition, SCS 6 may control access to the files based on specified criteria, such as a time-of-day, a source address, e.g., a domain name or a network address, a company name, an organizational unit, and a cipher size. SCS 6 may include a management tool that includes a number of components for managing the web folders. For example, the management tool may include a web-based graphical utility that creates and edits a property file to be used by the hosting web server. The screens presented by this utility may be used to edit the specified criteria.

The management tool of SCS 6 may further include an interface to an LDAP-based accounts management system, which may be used to authentic users and control access to the folders. The management tool may also include a utility that automatically restarts the web server to make the new governing rules active.

The attributes that govern a particular folder can be stored in an accounts management directory. In this way the rules can be accessed for governing other services in addition to the contents of a particular WebDAV folder.

SCS 6 not only provides secure management of folders accessed by numerous client computers, such as through their desktop file management system, but also provides secure management of folders accessed by other WebDAV-enabled SCSs.

The techniques described herein can be used to deploy secure web folders in any TCP/IP enabled network, for example. An example deployment could be in the health care industry where you have health care providers (hospitals and clinics) and payers (insurance companies and government agencies). An insurance company could use this technology to make available the secure web folders to providers who submit claims to them. A single server could host dozens of secure web folders, each appearing as a single folder on the desktop of an administrator at a participating provider. This would allow these dozens of clinics to put their claims on a single server at the insurance company.

A second example involves the interaction of multiple secure web folders. A system could be created for emergency disease information management. A secure web folder server could be set up at various county health departments. The physicians in these counties would all be given x509 certificates, along with the corresponding private keys, that allow them to access a folder on the county server. As a result, the physicians can drop their disease reports in their respective secure folders. The state or other organization would then host a secure web folder server that would have folders for each county. If the county health official felt that the physician's disease report was worth sending on to the state, this official would move the file from the physician's folder to their county's folder on the state system. There, the report could be reviewed by a state health official. Should this official feel that it was worthy of the attention of the federal Center for Disease Control, the official would put the report in their state's folder on the CDC.

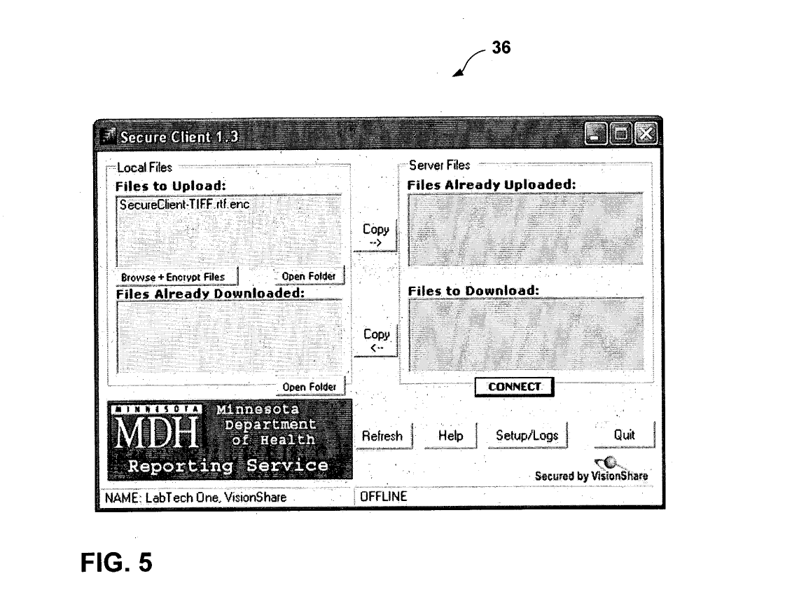

FIG. 5 is a screen shot that illustrates a GUI 36 provided by secure client process 12 that interacts with SCS 6B to provide security and ease-of-use services. Secure client process 12 encrypts files using the same techniques of SCS 6, e.g., using a PKI encryption model. This encryption model allows fully PKI encrypted files to be exchanged between secure client process 12 and SCS 6B to protect sensitive information. Secure client process 12 may download necessary encryption keys, such as PKI keys, from SCS 6B, which allows secure client process 12 to encrypt files for particular destinations within an enterprise. In this manner, individual business units within an enterprise can have information encrypted so that the information can only be accessed using the private key installed in respective SCSs of each business unit.

Secure client process 12 further automates the key installation process. Secure client process 12 provides fully automated key installation for the remote users, in turn, providing hands-off key installation. The hands-off approach provided by secure client process 12 eliminates the need for enterprise users to manually install keys, which reduces possible user errors in installations.

Secure client process 12 and SCS 6 communicate via a secure tunnel established via bidirectional authentication. Specifically, secure client process 12 and SCS 6 provide one another with authentication keys, such as PKI keys, that must cryptographically prove the identity. Bidirectional authentication ensures that hackers cannot hijack a particular transmission, nor can hackers steal the authentication since it does not use username and passwords. Further the bidirectional authentication ensures that the files are exchanged between trusted enterprise users.

Secure client process 12 provides an easy to use GUI to initiate communications with SCS 6. When the secure client process 12 starts, and an enterprise user asks to connect to a SCS 6. Secure client process 12 contacts a pre-authorized server for the configuration of the particular SCS 6. For example, the configuration file of the respective SCS may include all of the destinations available to the SCS within the respective enterprise. In other words, secure client process 12 can communicate securely with each business unit, using a unique public key automatically downloaded for each business unit, e.g., downloaded with the configuration information of the SCS 6. In this manner, secure client process 12 provides the enterprise user with a simple “pick-list” of destinations, using a full PKI model, but with a simple point-and-click interface to the user.

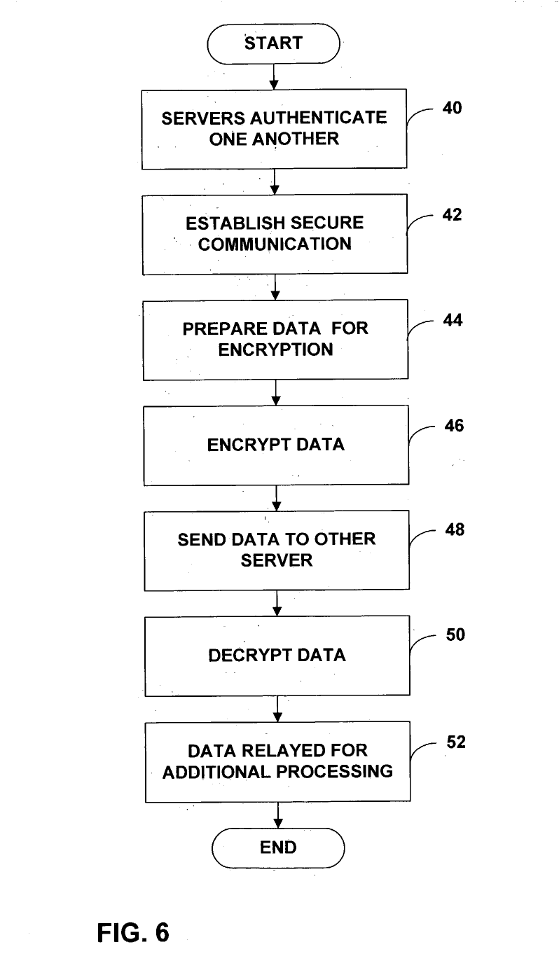

FIG. 6 is a flow diagram illustrating establishment of a direct, bi-directional secure communication flow between two SCSs 6. Initially, each of SCSs 6 authenticates the other using a cryptographic “handshake” (40). For example, SCSs 6 may exchange digital certificates and an encrypted piece of data as a token to prove the identities of each SCS 6. In other words, each SCS 6 must be in possession of a private key that corresponds to a unique public key contained in their x509 digital certificate obtained by the other SCS 6 in order to be authenticated. This bidirectional authentication ensures non-repudiation of the identity of the enterprise user at the other end of the encrypted communication tunnel.

Upon the bidirectional authentication of each other, SCSs 6 establish a secure communications between one another (42). The secure communication flow may be an encrypted SSL channel, a cryptographically authenticated tunnel, or the like.

Once established, SCSs 6 utilize the secure communication flow to exchange encrypted data. In particular, a source SCS prepares a respective data for encryption (44). Preparing the data for encryption may include obtaining an associated encryption key, such as a public key of a public-private key pair. The source SCS encrypts the data in accordance with the respective encryption key and sends the data to the SCS as a secure communication (46, 48). For example, real-time data may be encrypted and securely transmitted to a receiving SCS via a cryptographically authenticated tunnel. As another example, a file may be securely transmitted via an encrypted SSL channel.

Subsequently, the destination SCS decrypts the data on the receiving end using its private key (50). The encryption scheme used for transferring data ensures that only the destination SCS may decrypt the data by using the public/private key pair associated with the destination SCS. The destination SCS may relays the data to another server or computing device within the respective enterprise or to the enterprise user requesting the data for additional processing (52).

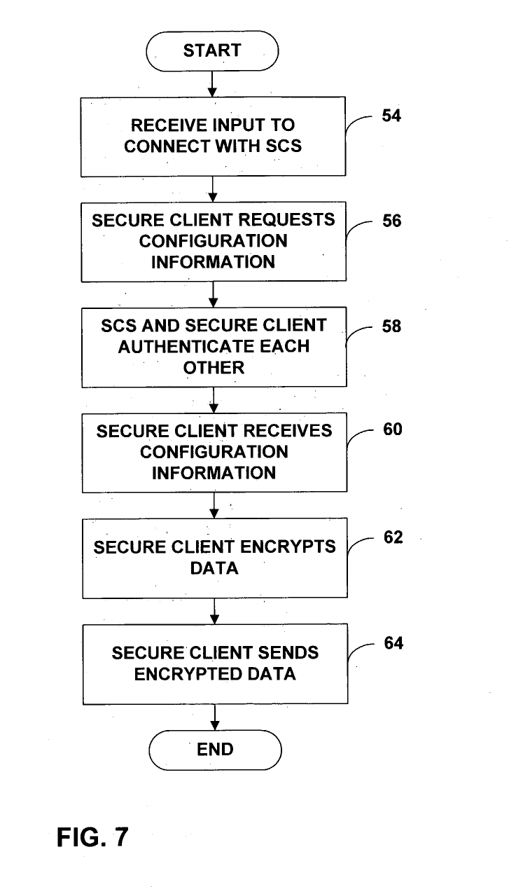

FIG. 7 is a flow diagram illustrating secure data transfer between a secure client process 12 and SCS 6B (FIG. 2). Initially secure client process 12 receives input from an enterprise user directing secure client process 12 to connect with SCS 6B (54). In response to the input from the enterprise user, secure client process 12 contacts SCS 6B to request additional configuration information for communicating with other destinations, possibly by other remote SCSs, e.g., SCS 6A (56). The configuration information may include destinations available within the respective enterprise as well as a public keys associated with the destinations.

Upon receiving the request, SCS 6B and secure client process 12 authenticate each other using authentication keys and/or digital certificates, as described above (58). For example, secure client process 12 and SCS 6 may provide one another with authentication keys, such as PKI keys, to cryptographically prove the identities of each other. This bidirectional authentication ensures that the files and other data are exchanged between trusted systems. Once the authentication has been performed, secure client process 12 may download necessary encryption keys, such as PKI keys, and configuration files from SCS 6, which allows secure client process 12 to encrypt files for particular destinations within an enterprise (60).

Secure client process 12 encrypts files with the corresponding authentication key and sends the encrypted files via an SSL tunnel established between SCS and secure client process 12 (62, 64). SCS may further receive encrypted files for secure client process 12 and store them in a directory for secure client process 12 to pick up and decrypt.

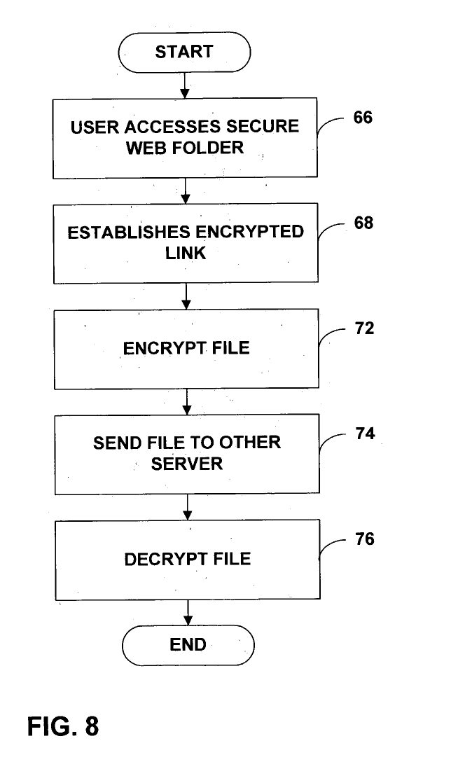

FIG. 8 is a flow diagram illustrating exemplary operation of SCS 6C (FIG. 2) allowing a remote enterprise user to access a secure web folder. A remote user accesses a secure web folder on a desktop of a computer (66). SCS 6C hosting the secure web folder and the remote user establish a tunnel between the computer used by remote user 16 and the SCS associated with the secure web folder (68). Specifically, SCS 6C authenticates remote user 16, for example, using a PKI certificate assigned to remote user 16. Upon validation of the PKI certificate of remote user 16, SCS 6C allows remote user 16 to access the secure file system directories. In this manner, SCS 6C provides an authenticated “tunnel” from remote user 16 to files hosted on another computer.

SCS 6C hosting the secure web folder encrypts the particular file or files requested by the remote enterprise user and sends the encrypted file or files to the remote user via the secure tunnel (72, 74). Remote user 16 decrypts the received file using a private key associated with a public/private key pair (76). The authentication occurs “behind the scenes.” In other words, the enterprise user accesses the secure web folder just like any folder on his/her hard drive.

Various embodiments of the invention have been described. These and other embodiments are within the scope of the following claims.

1. A method comprising:
requesting a secure communication flow between devices;
authenticating an identity of each of the devices using peer-to-peer authentication; and
establishing a secure communication flow between the devices upon authenticating the identity of each of the devices.

2. The method of claim 1, wherein authenticating the identity of each of the devices using peer-to-peer authentication includes:
exchanging digital certificates issued to the devices;
exchanging data encrypted with a private encryption key; and
authenticating of the device when the encrypted data is successfully decrypted with a public key from the digital certificates.

3. The method of claim 1, further comprising issuing a public/private encryption key pair to each of the devices.

4. The method of claim 3, wherein a central authority authorizes the use of the public/private encryption key pair for each of the devices for use in the peer-to-peer authentication.

5. The method of claim 1, further comprising transferring files between devices using the established secure communication flow.

6. The method of claim 1, further comprising:
managing a cryptographically protected file system with one of the devices; and
providing access to cryptographically protected file system upon authenticating the identity of another requesting device; and
sending the file to the requesting device via the established secure communication flow.

7. The method of claim 1, wherein the secure communication flow is between a server and a client device.

8. The method of claim 1, wherein the secure communication flow is between a server and a server.

9. A system comprising:
a first device; and
a second device, wherein the first and second devices authenticate identities of one another using peer-to-peer authentication, and establish a secure communication flow between the devices upon authenticating the identity of each of the devices.

10. The system of claim 9, wherein first and second device exchange digital certificates issued to the devices, exchange an encrypted piece of data as a token to prove the identity of the device, and validate the authentication of the device when the encrypted data is successfully decrypted with a public key from the digital certificate.

11. The system of claim 9, further comprising a centralized authority to issue digital certificates to devices for use in the peer-to-peer authentication.

12. The system of claim 9, wherein the first device is a secure communication server and the second device is a secure communication server.

13. The system of claim 9, wherein the first and second devices are secure communication servers.

14. A secure communication device comprising:
an authentication manager to authenticate an identity of another device using peer-to-peer authentication; and
a security manager to establish a secure communication flow to communicate with the device upon authentication.

15. The device of claim 14, wherein the authentication manager receives a digital certificate and an encrypted piece of data as a token to prove the identity of the device, and validates the authentication of the device when the encrypted data is successfully decrypted with a public key from the digital certificate.

16. The device of claim 14, wherein the security manager encrypts data using a public key of a public/private encryption key pair associated with the device and sends the encrypted data to the device via the secure communication flow.

17. The device of claim 14, further comprising a logging and reporting manager that tracks data flows across the secure tunnel.

18. The device of claim 14, further comprising a bridge service manager to confirm the validity of digital certificates issued by enterprises using different authentication environments.

19. The device of claim 18, wherein the bridge service manager verifies the identity of individuals accessing a secure message center.

20. The device of claim 19, wherein the secure message center securely exchanges electronic mail (e-mail) between a first set of users and a second set of users.

21. The device of claim 20, wherein the secure message center exchanges e-mail with the first set of users via an e-mail protocol, and wherein the secure message center presents a web-based interface for exchanging e-mails with the second set of users, and wherein the SMC provides secure communications with the first and second set of users using a digital certificate assigned to the secure message center.

22. The device of claim 14, further comprising an XML/SOAP interface to enable secure remote access to objects on the secure communication device.

23. The device of claim 14, wherein the security manager provides secure file transfers with the device.

24. The device of claim 14, wherein the security manager provides access to a cryptographically protected file system upon authenticating the identity of the device.

25. The device of claim 14, wherein the security manager provides secure transfer of data in real-time with the device.

26. A system comprising:
a server hosting a web-accessible, cryptographically protected file system; and
a client device to remotely access the file system, wherein the server requires a digital certificate and a private key to grant the client access to the file system.

27. The system of claim 26, wherein to control access the folder, the server and client device establish a secure communication tunnel based on a public key associated with the private key.

28. The system of claim 26, wherein the server controls access to the folder based on additional specified criteria including one of a time-of-day, an IP source address, a domain source address, a company name, an organizational unit, and a cipher size.
